(19) United States
(12) Patent Application Publication
(10) Pub. No.: US 2012/0244739 A1
(43) Pub. Date: Sep. 27, 2012

(54) PHOTOVOLTAIC PANEL CONNECTORS

(75) Inventor: Scott Youngkin, Springfield, MO (US)

(73) Assignee: POSITRONIC INDUSTRIES, INC., Springfield, MO (US)

(21) Appl. No.: 13/069,598

(22) Filed: Mar. 23, 2011

(51) Int. Cl. H01R 13/627; H01R 13/62

(52) U.S. Cl. 439/357; 439/345

(57) ABSTRACT

An electrical connector for photovoltaic solar panels generally includes a housing with an opening extending through it. Electrical contacts are mounted on the housing and extend into the opening. An attachment mechanism is adapted to connect the electrical connector to a second electrical connector. The ratio of the width to the thickness of the housing is at least about 5:1.

### FIELD OF THE INVENTION

The present invention generally relates to electrical connectors, and more specifically, to relatively thin electrical connectors for photovoltaic solar panels.

### BACKGROUND OF THE INVENTION

The use of solar panels on the roof of a structure to provide electricity to the structure is generally known. Recently, panels that can be used in place of roofing shingles have been developed, to enhance the aesthetic appeal of the solar panel system by maintaining a low profile and blending in with the remaining roofing shingles on the structure. However, the solar panels are often difficult to connect to each other, and generally require wires extending through the roof to connect each panel. This extensive connection process causes the cost of installing and maintaining the solar panel system to be very high. Therefore, a connection system that reduces the cost of installing and maintaining the solar panel system is desirable. Furthermore, the connection system should maintain the low profile and aesthetic appeal of solar panel systems that are used in place of roofing shingles.

### SUMMARY OF THE INVENTION

In one aspect, an electrical connector for photovoltaic solar panels generally comprises a housing. At least one opening extends through the housing. Electrical contacts are mounted on the housing and extend into the at least one opening. An attachment mechanism is adapted to connect the electrical connector to a second electrical connector. The housing has a width and a thickness. The ratio of the width to the thickness is at least about 5:1.

In another aspect, an electrical connection system generally comprises a first connector including a housing with a first end and two major surfaces. First and second openings extend through the two major surfaces of the housing. The second opening is spaced from the first opening. A first electrical contact is mounted on the housing and extends into the first opening. A second electrical contact is mounted on the housing and extends into the second opening. A first attachment member is located on the housing of the first connector. A second connector includes a housing with a first end and two major surfaces. First and second openings extend through the two major surfaces of the housing. The second opening is spaced from the first opening. A first electrical contact is mounted on the housing and extends into the first opening. A second electrical contact is mounted on the housing and extends into the second opening. A second attachment member is located on the housing of the second connector. The first connector and the second connector are mateable to establish electrical connection of the electrical contacts. The first and second attachment members are engageable to lock the first and second connectors together.

Other objects and features will be in part apparent and in part pointed out hereinafter.

### BRIEF DESCRIPTION OF THE DRAWINGS

FIG. 1 is a schematic perspective of a roof of a structure with photovoltaic panels connected by electrical connectors of the present invention;

FIG. 2 is an enlarged fragmentary view of the roof;

FIG. 3 is a perspective of a male electrical connector according to the present invention;

FIG. 4 is a bottom perspective thereof;

FIG. 5 is an exploded view of the male electrical connector;

FIG. 6 is a front view of the male electrical connector;

FIG. 7 is a perspective of a female electrical connector according to the present invention;

FIG. 8 is a bottom perspective thereof;

FIG. 9 is an exploded view of the female electrical connector;

FIG. 10 is a front view of the female electrical connector;

FIG. 11 is a perspective in section of a male electrical connector and a female electrical connector partially connected together;

FIG. 12 is a perspective of a male electrical connector and a female electrical connector connected together;

FIG. 13 is a section taken in a plane including line 13-13 in FIG. 12;

FIG. 14 is a partially exploded perspective of a female shunt connector;

FIG. 15 is a fragmentary perspective of a male pigtail connector; and

FIG. 16 is another fragmentary perspective of a male pigtail connector.

Corresponding reference characters indicate corresponding parts throughout the drawings.

### DESCRIPTION OF THE PREFERRED EMBODIMENTS

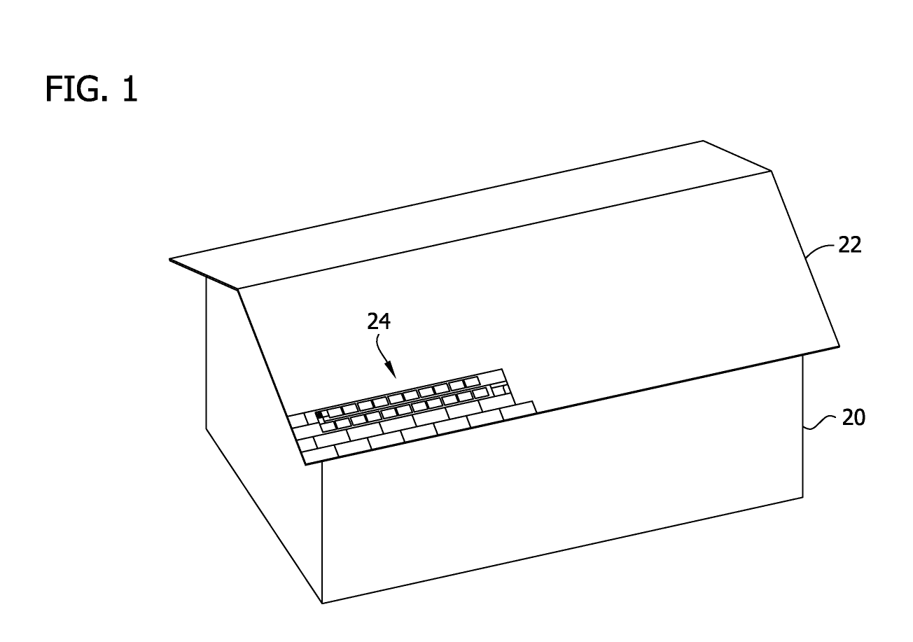

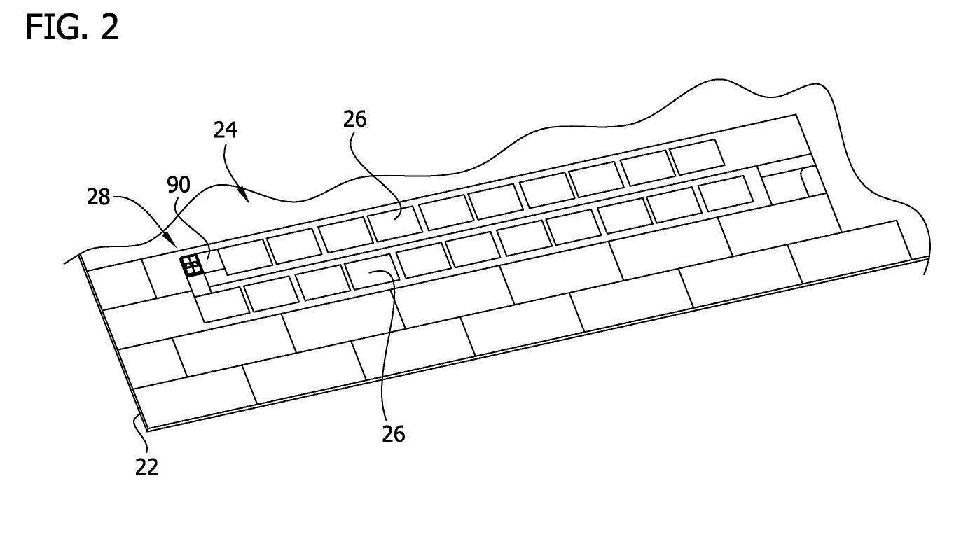

Referring to FIG. 1, a structure 20 having a roof 22 with a photovoltaic solar panel system generally indicated at numeral 24 is schematically illustrated. FIG. 2 shows a closer view of the system 24, which includes photovoltaic solar panels 26 connected by electrical connectors 28. Only a few solar panels 26 are shown in FIGS. 1 and 2, but up to the entire roof 22 may be covered with solar panels. Electrical connectors 28 of the solar panels 26 can be mated to electrically connect the solar panels in series, as will be described in further detail below. In the embodiment described, the electrical connectors 28 include male connectors 128, female connectors 228, female shunt connectors 328 and male pigtail connectors 428, all described in more detail hereinafter. More or fewer types of connectors could be provided within the scope of the present invention.

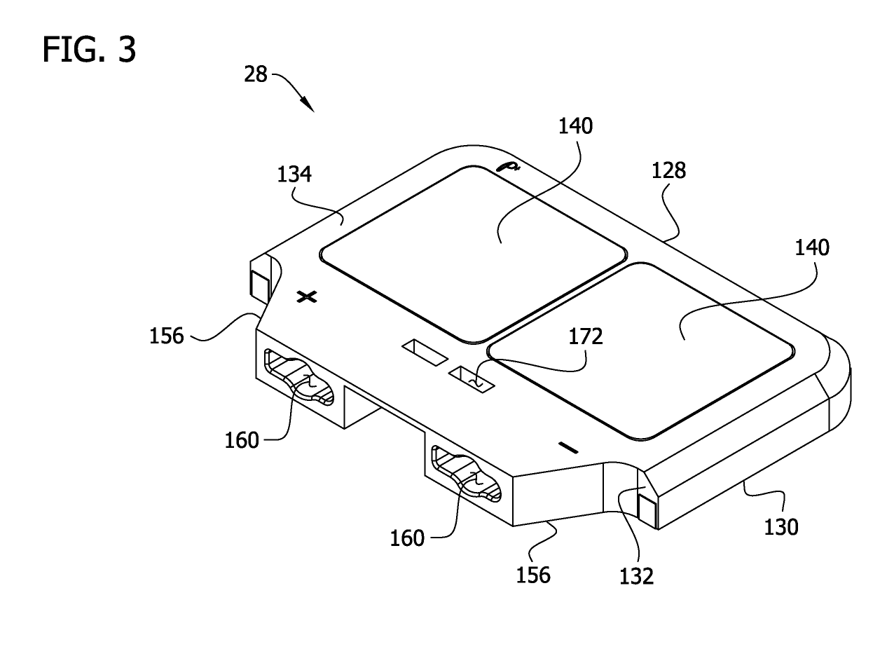

In FIGS. 3-6, male electrical connector 128 includes a housing 130 with a first end 132 and two major surfaces, top surface 134 and bottom surface 136. A central plane of the housing 130 is parallel to and located approximately halfway between top surface 134 and bottom surface 136. First end 132 of male connector 128 is keyed to allow mating of the male connector with other electrical connectors 28 in only one relative orientation, as will be described below.

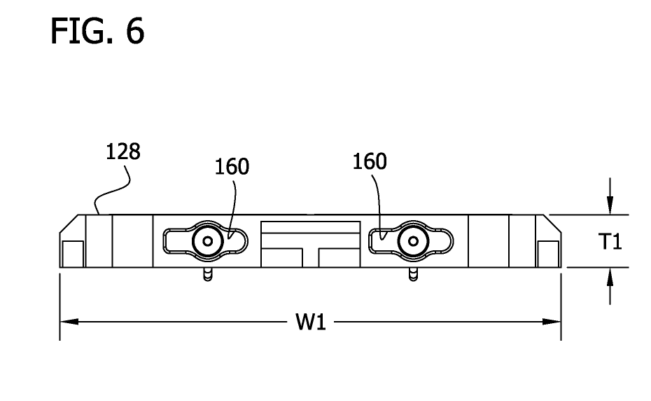

Housing 130 has a width W1 and a thickness T1, as seen in FIG. 6. Preferably the ratio of the width W1 to the thickness T1 is at least about 5:1. More preferably, the ratio is at least about 9:1. Preferably, the thickness T1 is less than about 7 mm, to minimize the profile of the solar panel system 24 at the connection points. In one embodiment, housing 130 has a width W1 of approximately 49.5 mm, and a thickness T1 of approximately 5.18 mm.

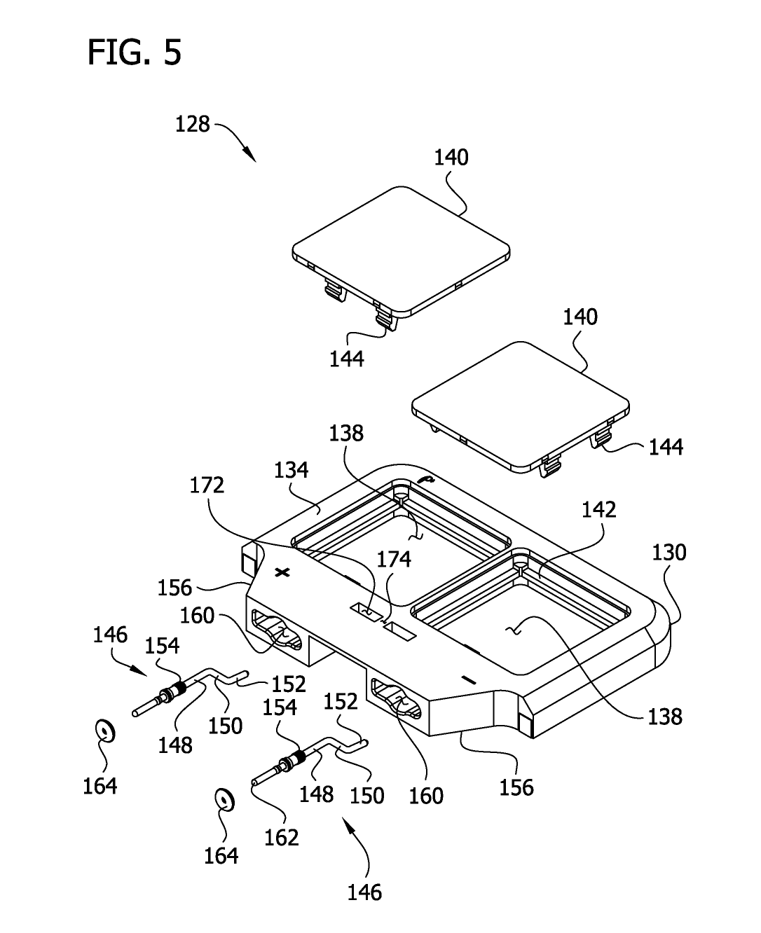

In the illustrated embodiment, housing 130 has two openings 138 spaced from each other that extend through the top and bottom (major) surfaces 134, 136 transversely of the central plane. As best seen in FIGS. 3 and 5, male connector 128 preferably includes a cap 140 to cover each opening 138. Opening 138 includes a ledge 142 projecting into the opening. Ledge 142 extends around the perimeter of the opening 138, and is configured to provide a snap-fit with cap 140. Cap 140 is sized and shaped to fit within a top portion of opening 138, such that a top surface of the cap is substantially flush with top surface 134 of housing 130. Fasteners 144 located on cap 140 engage the ledge 142, such as by a snap fit, to connect the cap to housing 130. In use, as is described below, opening 138 is filled with epoxy. Before the epoxy cures, cap 140 is snapped onto ledge 142 to cover opening 138 and the epoxy therein. It will be understood that the cap 140 may be omitted within the scope of the present invention.

Housing 130 further includes an attachment mechanism to facilitate connection of two electrical connectors 28. In the illustrated embodiment, the attachment mechanism on male connector 128 includes a protrusion 156 extending outwardly from the remainder of the housing. Protrusion 156 defines a passage 160 extending from the free end of the protrusion into opening 138. As illustrated, housing 130 includes two protrusions 156 so that each opening 138 has a corresponding protrusion and passage 160. Passage 160 is asymmetrically shaped at the free end of the protrusion. As best seen in FIG. 6, the left and right sides of the opening are shaped differently.

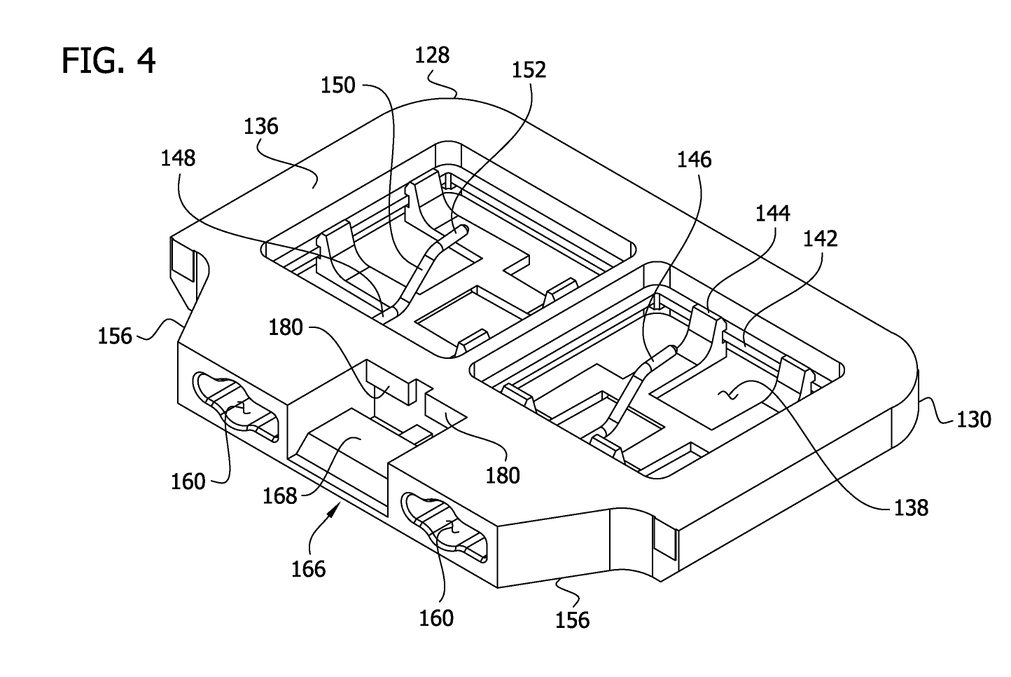

Male connector 128 includes electrical contacts 146 mounted on the housing 130. Each contact 146 extends into an opening 138, as best seen in FIG. 4. A first portion 148 of each contact 146 extends parallel to the central plane of the housing 130. A second portion 150 extends at an angle from the first portion 148, and a third portion 152 extends at an angle from the second portion. In one embodiment, third portion 152 of electrical contact 146 extends parallel to the central plane and parallel to first portion 148. As illustrated, second and third portions 150, 152 of electrical contact 146 extend into opening 138, and first portion 148 is substantially located within passage 160 in protrusion 156. First portion 148 preferably includes a knurled segment 154 that engages housing 130 and helps to seal the passage 160 at the opening 138. The knurled segment 154 locks the contact 146 against rotation relative to the housing 130 about a longitudinal axis of the contact. An O-ring 164 is disposed on each electrical contact 146 of male connector 128 to prevent ingress of water when connected with the contact of another electrical connector 28, as is described below.

Housing 130 also includes a locking mechanism to releasably lock male connector 128 to another electrical connector 28. The locking mechanism includes an attachment member located on each connector 28. The attachment member 166 of the male connector 128 includes a latch catch 168 located on housing 130 (see FIG. 4). The latch catch 168 is located between protrusions 156. A slot 172 in housing 130 allows the attachment member 166 to be unlocked from an attachment member of another electrical connector 28, as will be described below. A latch stop 180 located below slot 172 constrains the movement of an attachment member of another electrical connector 28 attached to male connector 128. Preferably, disengagement of the attachment members of male connector 128 and another connector 28 requires use of a suitable tool. A rib 174 extends across slot 172 to prevent the connectors 28 from being unlocked with a fingernail.

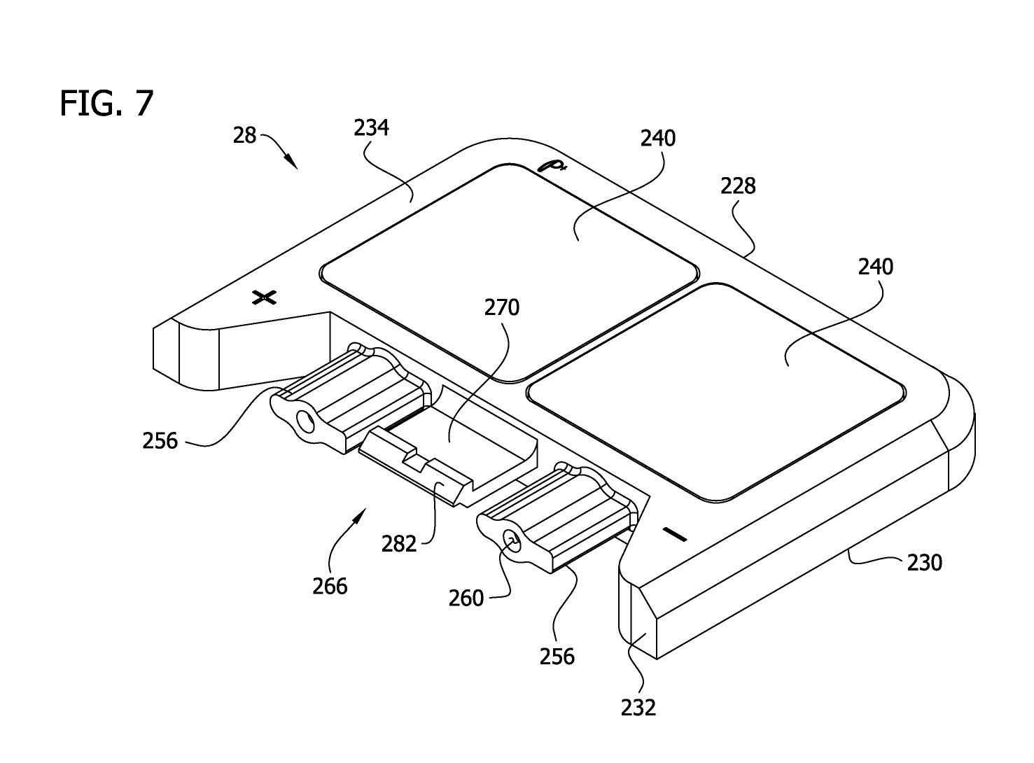

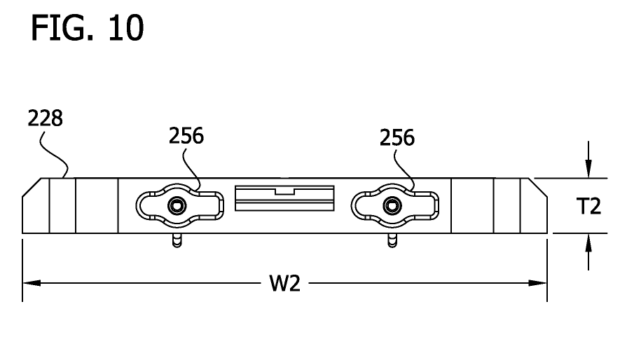

In FIGS. 7-10, the female electrical connector 228 includes a housing 230 with a first end 232 and two major surfaces, top surface 234 and bottom surface 236. A central plane of the housing 230 is parallel to and located approximately halfway between top surface 234 and bottom surface 236. A first end of female connector 228 is keyed to allow mating of the female connector with other electrical connectors 28 in only one relative orientation, as will be described below. Housing 230 has a width W2 and a thickness T2, as seen in FIG. 10. Preferably the ratio of the width W2 to the thickness T2 is about the same as that of the housing 130 of the male connector 128. It will be understood that the housing 230 may have a different width-to-thickness ratio than the housing 130 within the scope of the present invention.

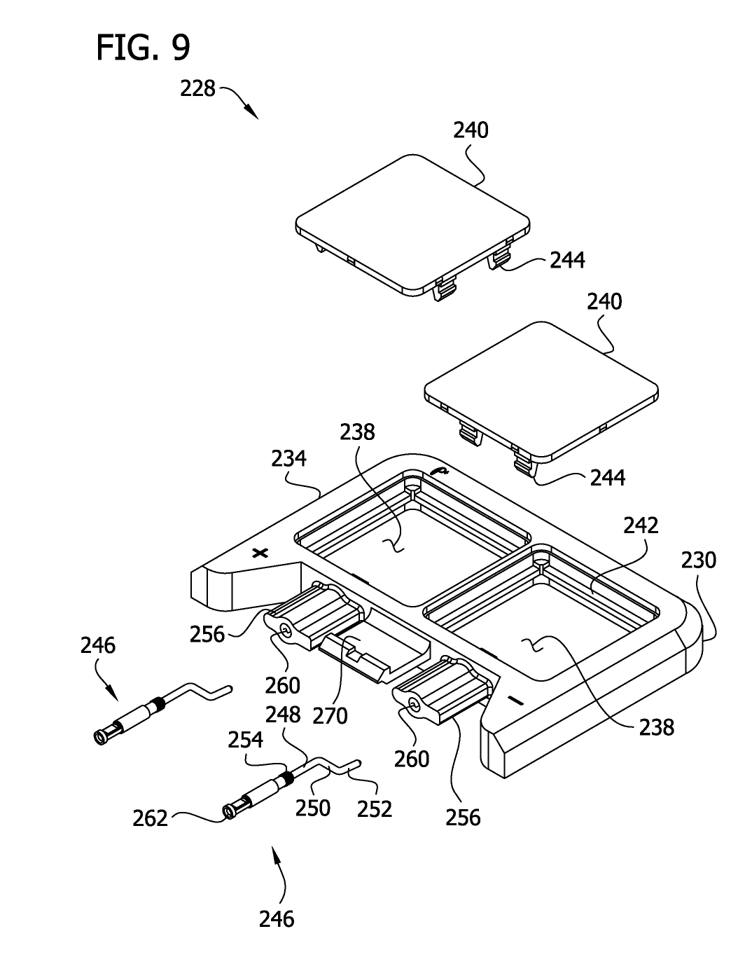

At least one opening 238 extends through the housing 230. In the illustrated embodiment, housing 230 has two openings 238 spaced from each other that extend through the top and bottom (major) surfaces 234, 236 transversely of the central plane. As best seen in FIGS. 7 and 9, female connector 228 preferably includes a cap 240 to cover each opening 238. Opening 238 includes a ledge 242 projecting into the opening. Ledge 242 extends around the perimeter of the opening 238, and is configured to provide a snap-fit with cap 240. Cap 240 is sized and shaped to fit within a top portion of opening 238, such that a top surface of the cap is substantially flush with top surface 234 of housing 230. Fasteners 244 located on cap 240 engage the ledge 242, such as by a snap fit, to connect the cap to housing 230.

Housing 230 further includes an attachment mechanism to facilitate connection of two electrical connectors 28. In the illustrated embodiment, the attachment mechanism on female connector 228 includes a protrusion 256 extending outwardly from the remainder of the housing to a free end. Protrusion 256 defines a passage 260 extending from its free end to opening 238. As illustrated, housing 230 includes two protrusions 256 so that each opening 238 has a corresponding protrusion and passage 260. The passage is generally cylindrical and is adapted to receive an electrical contact 246. Protrusion 256 is sized and shaped to facilitate connection of female connector 228 with other electrical connectors 28 in only one predetermined orientation, which connection will be described below. Protrusion 256 is asymmetrically shaped. As best seen in FIG. 10, the left and right sides of protrusion are shaped differently. Protrusion 256 has substantially the same shape as passage 160 of male connector 128 as described above.

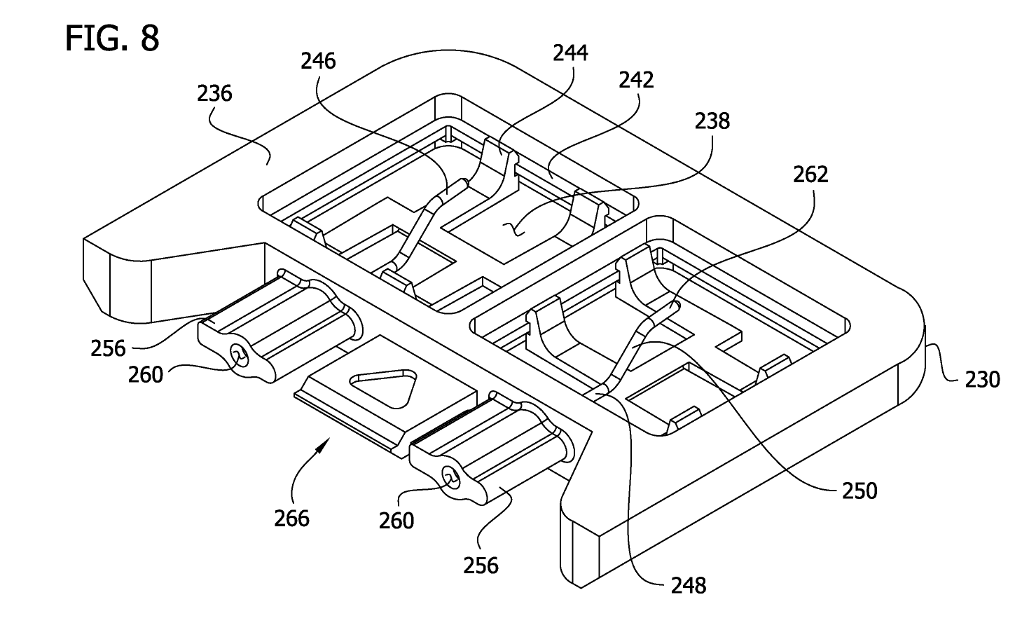

Female connector 228 includes electrical contacts 246 mounted on the housing 230. Each contact 246 extends into an opening 238, as best seen in FIG. 8. A first portion 248 of each contact 246 extends parallel to the central plane of the housing 230. A second portion 250 extends at an angle from the first portion 248, and a third portion 252 extends at an angle from the second portion. In one embodiment, third portion 252 of electrical contact 246 extends parallel to the central plane and parallel to first portion 248. As illustrated, second and third portions 250, 252 of electrical contact 246 extend into opening 238, and first portion 248 is substantially located within passage 260 in protrusion 256. First portion 248 preferably includes a knurled segment 254 that is configured to engage housing 230. The knurled segment 254 locks the contact 246 against rotation relative to the housing 230 about a longitudinal axis of the contact.

Housing 230 also includes a locking mechanism to releasably lock female connector 228 to another electrical connector 28. The locking mechanism includes an attachment member located on each connector 28. The attachment member 266 of the female connector 228 includes a latch 270 located on housing 230 (see FIG. 7). Preferably, latch 270 is located between protrusions 256. Latch 270 includes a beveled surface 282 that can be pressed to disengage the latch 270 from an attachment member of another electrical connector 28, as will be described below.

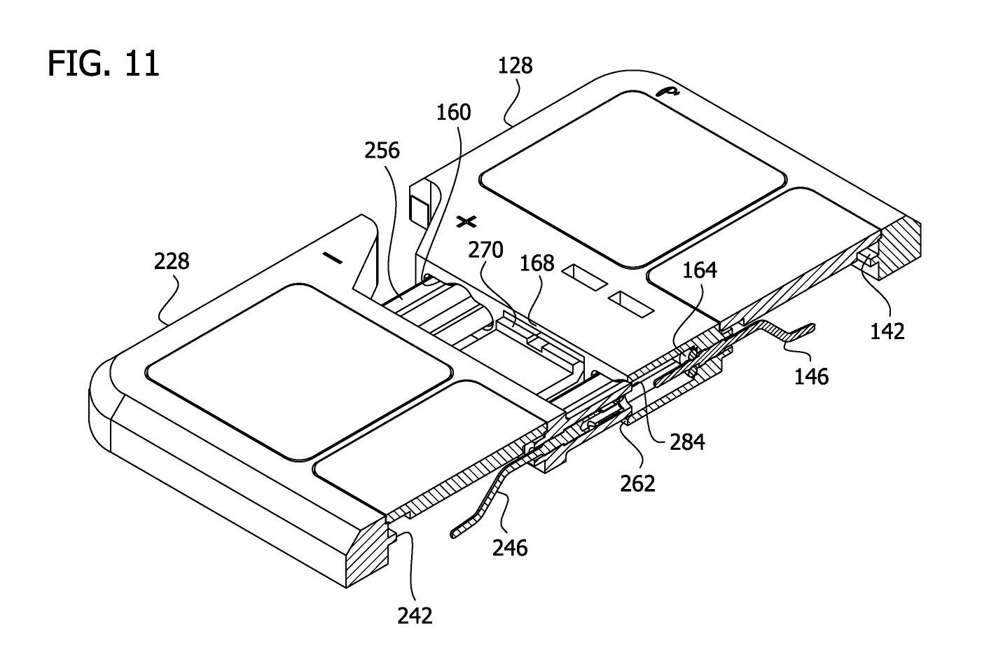

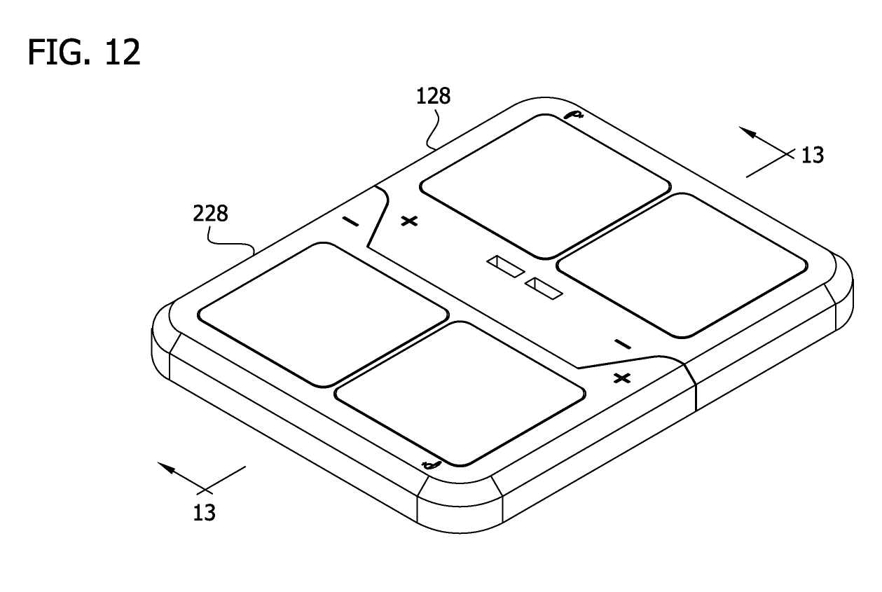

FIGS. 11-13 illustrate how two electrical connectors 28 can be connected. FIG. 11 shows a male connector 128 and a female connector 228 partially engaged, though not fully mated. Protrusion 256 of female connector 228 is received in passage 160 of male connector 128. Because of the asymmetric shape of protrusion 256 and passage 160, connection of male and female connectors 128, 228 is permitted in only one predetermined orientation. When connectors 128, 228 are aligned in this manner, each portion of the protrusion 256 can be received in a correspondingly shaped portion of passage 160.

The electrical contacts 146, 246 engage to provide an electrical connection of connectors 128, 228. A receptacle 262 of first portion 248 of female electrical contact 246 of female connector 228 is configured to receive a free end of first portion 148 of the male electrical contact 146, as is known in the art (see also FIGS. 5 and 9). A front surface 284 of protrusion 256 compresses O-ring 164 when connectors 128, 228 are fully mated. This compression causes the O-ring 164 to seal at all surfaces it contacts, thereby preventing water from reaching the contacts 146, 246.

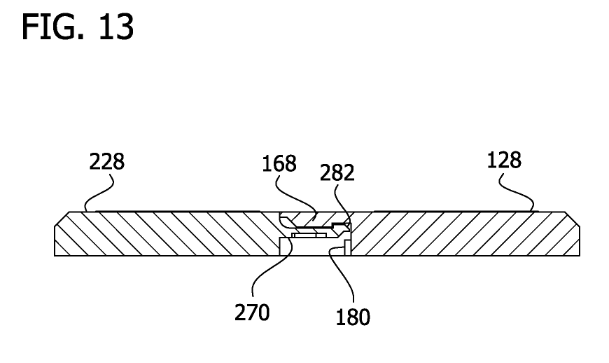

FIG. 13 illustrates how the locking mechanism functions to lock connectors 128, 228 together. Latch catch 168 of male connector 128 engages latch 270 of female connector 228. To disengage the latch 270, a tool is inserted into slot 172 and contacts the beveled surface 282 of the latch. The latch 270 deflects downward because of the contact on the beveled surface 282, and thereby disengages from latch catch 168. The male and female connectors 128, 228 may then be separated.

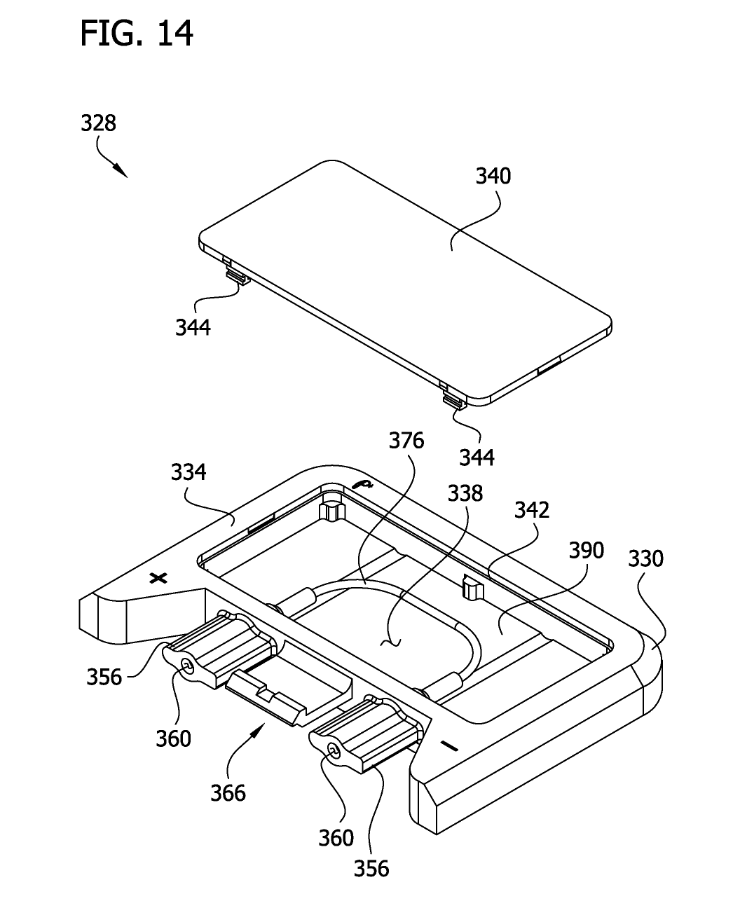

As shown in FIG. 14, a female shunt electrical connector 328 is substantially identical to female electrical connector 228, except for differences pointed out hereinafter. Housing 330 of shunt connector 328 includes an attachment mechanism comprising protrusions 356, identical to protrusions 256 described above. However, housing 330 preferably includes only one large opening 338, and both passages 360 of protrusions 356 extend into the single opening 338. Opening 338 extends through top surface 334 to a base 390. Ledge 342 projects into the opening 338, and a single cap 340 is configured to cover opening 338. In use, opening 338 is filled with epoxy. Before the epoxy cures, cap 340 is placed on the housing 330 to cover opening 338 and the epoxy therein. Anchors 344 of the cap 340 sink into the epoxy before it hardens, thereby anchoring the cap to the housing 330. It will be understood that the cap 340 may be omitted within the scope of the present invention, or may have a different configuration, such as a fastener to engage the ledge 342. Furthermore, a shunt 376 connects the two electrical contacts 346 in the opening 338. Because the shunt connector 328 has protrusions 356 and attachment member 366 identical to female connector 228 described above, shunt connector 328 can be mated with a male connector 128, as described above.

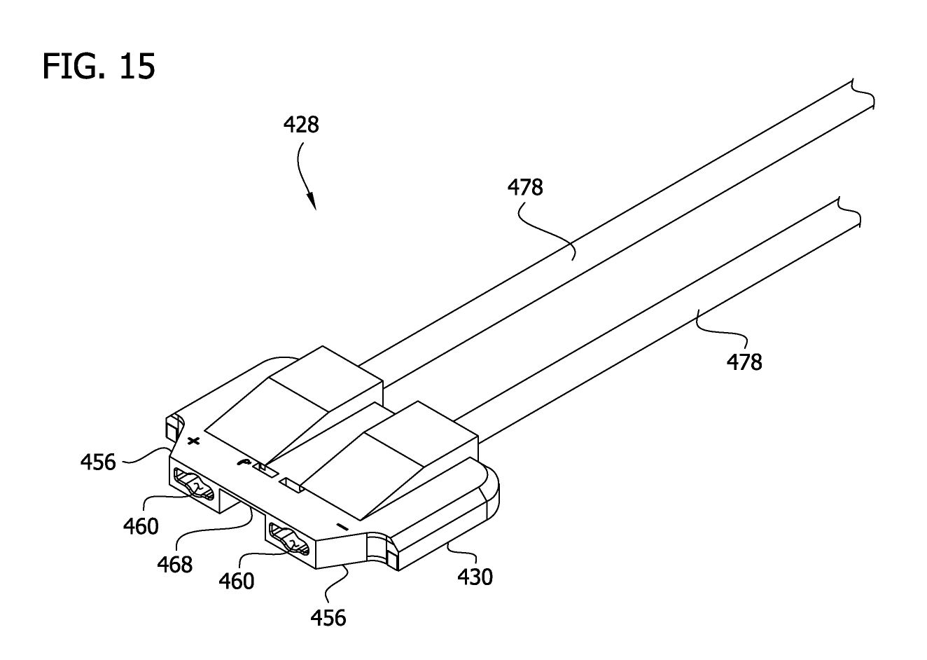

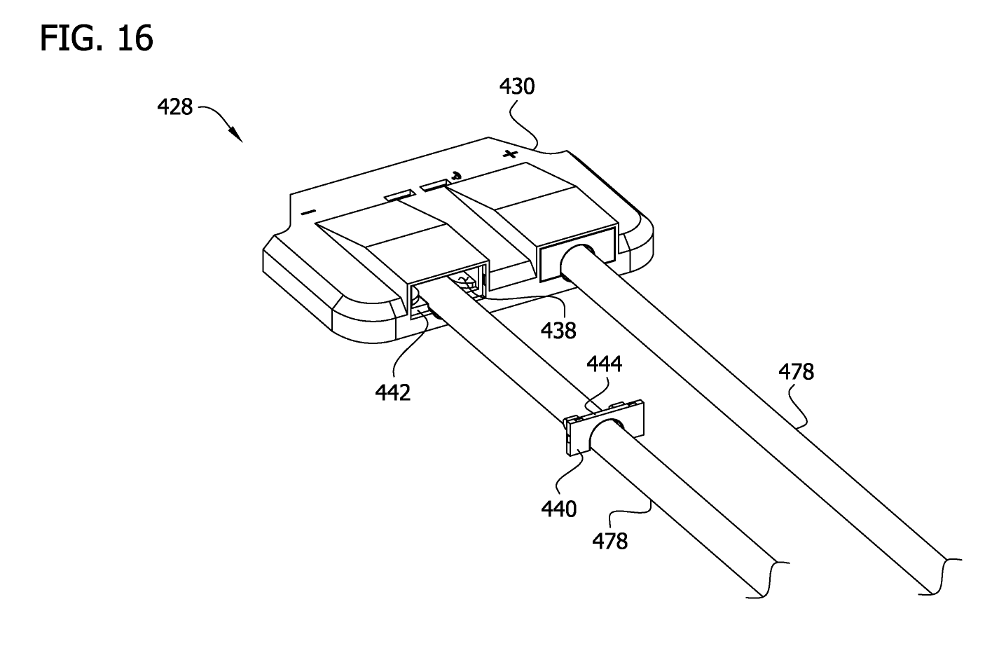

FIGS. 15 and 16 show a male pigtail connector 428, which has an attachment mechanism and a locking mechanism identical to male electrical connector 128, described above. More specifically, male pigtail connector 428 includes protrusions 456 and latch catch 468 identical to protrusions 156 and latch catch 168 on male electrical connector 128. Thus, male pigtail connector 428 can be mated with female connector 228. Male pigtail connector 428 includes two wires 478, and more specifically, two 14-gauge photovoltaic wires extending out of the housing 430. The wires 478 are electrically connected to the electrical contacts 246 of the connector 228 mated with the pigtail connector 428. An opening 438 in the housing 430 through which each wire 478 extends can be covered with a cap 440. Opening 438 also contains a ledge 442. In use, opening 438 is filled with epoxy. Before the epoxy cures, cap 440 is placed on the housing 430 to cover opening 438 and the epoxy therein. Anchors 444 of the cap 440 sink into the epoxy before it hardens, thereby anchoring the cap to the housing 430. It will be understood that the cap 440 may be omitted within the scope of the present invention, or may have a different configuration, such as a fastener to engage the ledge 442.

Use of the illustrated embodiment to provide solar energy to a structure will now be described. Photovoltaic solar panels 26 are arranged on a roof 22 of a structure 20 (FIGS. 1 and 2). Each solar panel includes a tab 90 with a copper bus bar (not shown) embedded in the tab. The panels 26 are used to collect solar energy for use in the structure 20, as is known in the art. An electrical connector 28 is mounted on each tab 90 using a gasket material. The electrical connector 28 mounted on each tab 90 can be any type of connector described above. For illustration purposes, a description of one tab 90 with a male connector 128 mounted thereon will be given. Third portion 152 of each electrical contact 146 is soldered to the copper bus bar to provide an electrical connection. The opening 138 is filled with epoxy to pot the contact 146 and further adhere the male connector 128 to the tab 90. The epoxy forms around and locks onto the ledges 142 in the openings 138 to hold the male connector 128 on the tab 90. The caps 140 are snapped into the openings 138 to cover the side of the epoxy opposite the tab 90. It is understood that a female connector 228 can be mounted on a tab 90 in the same way.

The solar panels 26 are then electrically connected to each other by mating a male connector 128 on one panel to a female connector 228 on another panel. The connectors are arranged such that when two connectors 128, 228 are mated, the female connector 228 is located on the downward side of a slope of the roof 22. Therefore, the male connector 128 is on the upward side of the slope, and any water or debris traveling down the slope of the roof 22 is precluded from reaching the electrical contacts 146, 246 by the sealing O-ring 164.

At one end of the series of connected solar panels 26, a female shunt connector 328 is mated to a male connector 128, thereby closing the electrical circuit of the photovoltaic solar panel system 24. At another end of the series of connected panels 26, a male pigtail connector 428 is mated to a female connector 228. Wires 478 extending from the male pigtail connector 428 are fed through a hole (not shown) in the roof decking to connect to an AC converter (not shown) in the structure 20, thereby transferring electrical current and allowing the energy from the panels to be used as electric power for the structure.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. An electrical connector for photovoltaic solar panels, the electrical connector comprising:
a housing having at least one opening extending through the housing;
electrical contacts mounted on the housing and extending into the at least one opening; and
an attachment mechanism adapted to connect the electrical connector to a second electrical connector;
the housing having a width and a thickness, the ratio of the width to the thickness being at least about 5:1.

2. The electrical connector of claim 1 wherein the width to thickness ratio of the housing is at least about 9:1.

3. The electrical connector of claim 1 wherein each of the electrical contacts has a first portion extending parallel to a central plane of the housing, a second portion of the electrical contact extending at an angle to the central plane from the first portion, and a third portion of the electrical contact extending at an angle to the second portion.

4. The electrical connector of claim 3, wherein the third portion of the electrical contact extends parallel to the central plane and parallel to the first portion.

5. The electrical connector of claim 3 wherein the third portion of each electrical contact is located in said at least one opening of the housing.

6. The electrical connector of claim 4 wherein the housing further comprises protrusions extending outwardly from a remainder of the housing, the first portions of the electrical contacts being located in the protrusions.

7. The electrical connector of claim 1 further comprising an O-ring disposed on each of the pair of electrical contacts.

8. The electrical connector of claim 1 wherein each electrical contact includes a knurled segment engaged with the housing.

9. The electrical connector of claim 1 wherein the connector has a central plane, said at least one opening extending transversely of the central plane, said at least one opening including a ledge projecting into said at least one opening.

10. The electrical connector of claim 1 further comprising at least one cap connectable to the housing for covering one end of said at least one opening.

11. The electrical connector of claim 1 further comprising a locking mechanism for locking the electrical connector in connection with another electrical connector.

12. The electrical connector of claim 1 comprising protrusions extending from a first end of the housing away from the at least one opening to a free end, each protrusion defining a passage extending through the protrusion from the free end of the protrusion to said at least one opening.

13. The electrical connector of claim 12 wherein the protrusions are asymmetrically shaped for permitting connection with another connector in only a single, selected orientation.

14. The electrical connector of claim 1 further comprising a shunt connector connecting the electrical contacts to each other.

15. An electrical connection system comprising:
a first connector comprising:
a housing having a first end and two major surfaces;
a first opening extending through the two major surfaces of the housing;
a second opening extending through the two major surfaces of the housing, the second opening being spaced from the first opening;
a first electrical contact mounted on the housing and extending into the first opening;
a second electrical contact mounted on the housing and extending into the second opening;
a first attachment member located on the housing of the first connector;
a second connector comprising:
a housing having a first end and two major surfaces;
a first opening extending through the two major surfaces of the housing;
a second opening extending through the two major surfaces of the housing, the second opening being spaced from the first opening;
a first electrical contact mounted on the housing and extending into the first opening;
a second electrical contact mounted on the housing and extending into the second opening;
a second attachment member located on the housing of the second connector; and
wherein the first connector and the second connector are mateable to establish electrical connection of the electrical contacts, and the first and second attachment members are engageable to lock the first and second connectors together.

16. The electrical connection system of claim 15 wherein the housing of the first connector includes protrusions projecting outwardly from the remainder of the housing, the protrusions defining passages each extending from a free end of one of the protrusions to a respective one of the first and second openings in the housing, and the housing of the second connector includes protrusions projecting outwardly from the remainder of the housing, the protrusions defining passages each extending from a free end of one of the protrusions to a respective one of the first and second openings in the housing, the first and second electrical contacts of the first and second connectors being received in respective ones of the passages.

17. The electrical connector system of claim 16 wherein the protrusions of the second electrical connector are sized and shaped to be received in the passages of the protrusions of the first electrical connector for bringing the electrical contacts of the first electrical connector into electrical connection with the electrical contacts of the second electrical connector.

18. The electrical connector system of claim 17 wherein the protrusions of the second electrical connector and the passages of the first electrical connector protrusions are shaped to permit connection of the first and second electrical connectors in only one, predetermined orientation.

19. The electrical connector system of claim 15 wherein the first and second attachment members are constructed for releasably, snap-together locking engagement.

20. The electrical connector system of claim 19, wherein the second attachment member comprises a latch and the first attachment member comprises a latch catch adapted to engage the latch.

21. The electrical connector system of claim 20, wherein the first housing further comprises a slot adapted to allow access to the latch of the second connector for disengaging the latch from the latch catch.

22. The electrical connector system of claim 21, wherein the first housing further comprises a rib extending across the slot to prevent the first and second attachment members from being disengaged using only a fingernail.

23. The electrical connector system of claim 15 wherein the ratio of the width to thickness of the housing of each of the first and second electrical connectors is at least about 5:1.

24. The electrical connector system of claim 15, wherein the ratio of the width to the thickness of the housing of each of the first and second electrical connectors is at least about 9:1.

25. The electrical connection system of claim 15 wherein each of the electrical contacts of the first connector further comprises an O-ring disposed thereon.

26. The electrical connection system of claim 15 wherein each of the electrical contacts has a first portion extending parallel to a central plane of the respective housing, a second portion of the electrical contact extending at an angle to the central plane from the first portion, and a third portion of the electrical contact extending at an angle to the second portion.

27. The electrical connector of claim 26, wherein the third portion of each electrical contact extends parallel to the central plane and parallel to the first portion.

28. The electrical connection system of claim 15 wherein each electrical contact includes a knurled segment engaged with the respective housing.

29. The electrical connection system of claim 15 wherein the first and second electrical connectors each has a central plane, the openings of each of the first and second electrical connectors extending transversely of the respective central plane, each of the openings including a ledge projecting into the opening.

30. The electrical connection system of claim 15 further comprising caps connectable to the housings for covering ends of the openings.

31. The electrical connection system of claim 15 further comprising a third electrical connector including:
a housing having a top surface and a base;
an opening extending through the top surface of the housing to the base;
electrical contacts mounted on the housing and extending into the opening; and
a shunt connector connecting the electrical contacts to each other.

32. The electrical connection system of claim 15 further comprising a third electrical connector including:
a housing; and
at least one wire extending from the housing, the wire being configured to connect to an electrical system of a structure.
